(19) United States
(12) Patent Application Publication
(10) Pub. No.: US 2010/0230440 A1
(43) Pub. Date: Sep. 16, 2010

(54) Heated Caulking Gun

(75) Inventor: Dan Cardea, Villa Park, IL (US)

Correspondence Address: EDELSON IP LAW GROUP, LTD., PO BOX 230, DEERFIELD, IL, 60015, US

(73) Assignee: H3rd Enterprises LLC, Villa Park, IL (US)

(21) Appl. No.: 12/404,323

(22) Filed: Mar. 15, 2009

(51) Int. Cl. B67D 5/62

(52) U.S. Cl. 222/146.5

(57) ABSTRACT

A caulking gun apparatus is described. In one embodiment the caulking gun assembly includes a heating element axially coupled along the extended barrel of the caulking gun containing the extended receiving chamber for the inserted cartridge containing the caulk material. The heating element comprises a plurality of elongated piano hinges which couple the heating element to an insulated wrap that fits over the outside of the cartridge tube holder. The cartridge tube holder accordingly comprises an axially structured heating element rounded to conform to the rounded surface for the cartridge tube so as to apply heat to the surface of the tube over the outer surface of the tube. In one aspect of use the heated caulking gun, the caulking gun assembly applies heat to the caulk tube cartridge to heat the caulk material within the cartridge to apply the caulk material during ambient temperatures. The insulated wrap containing the heating element insulates the contained cartridge and caulking gun as a wrapped unit. The dispensing nozzle of the caulking cartridge projects though the applied insulated wrap encircling the caulking gun embodiment comprising the caulking gun, the cartridge of caulk material, and the applied heating element and wherein the operating handle of the caulking gun, the piston shaft assembly projects from the insulation wrap for user control.

### FIELD OF THE INVENTION

The present invention relates to caulking guns generally and the ability to deliver an even flow of caulk when outside temperatures are cold by means of a caulking gun.

### BACKGROUND OF THE INVENTION

Caulk is usually contained as purchased in a pre-sized package. The caulk cartridges tend to be uniform in size. One end of the caulk cartridge has a nozzle through which the caulk is dispensed. Typically, a moveable structure within the caulk cartridge pushes the caulk toward the nozzle for delivery to the object necessary to be caulked.

Operatively, mechanical caulk guns do not provide an even delivery of caulk due to user's differing hand strength, ability to hold a steady grip, the temperature of the environment surrounding the caulk cartridge and the caulk gun, and the object receiving the caulking. In a climate or environment where the temperature surrounding the caulk is cold, the flow of the caulk can be uneven, or non-existent. Further, the user of the caulk gun can fatigue more easily in cold weather, and the caulk tends to be unevenly delivered to the object to be caulked.

There are also several electric caulk guns on the market to help ease the fatigue of the user, and allow completion of the project to be expedited. None however controls the temperature around the caulk to provide an even flow of the caulk, and allow control of the temperature of the caulk inside the caulk cartridge. The uneven temperature of the caulk reduces the efficiency of completing the project, and both fatigues the user and provides for less than efficient delivery of the caulk. Further, the caulk does not have a smooth flow and the seal or bond is less than ideal. The uneven flow of caulk requires additional reworking after caulking of the items has been completed such as cutting and scraping by the user to provide a more pleasing aesthetic appearance to the objects. At times, recaulking of the areas previously caulked is required because in an attempt to provide a pleasing appearance, the amount of caulk removed may be greater than what was intended and a sufficient seal of the items is absent. An even flow of caulk material to the items to be sealed or bonded would help eliminate this additional work and provide for the appearance the user desires at the outset of the task.

The present invention provides for a heated even flow of caulk, and allows the user to caulk items in cold environments. The present invention further provides for completion of the project in an expedient period, with a less likelihood of fatigue to the user. The present invention also provides a professional appearance of the caulked items, because of the ability of the user to deliver an even flow of caulk to the items at hand.

### DESCRIPTION OF THE RELATED ART

Generally caulking guns are designed primarily for dispensing caulk packaged in a cylindrical container or cartridge. The cartridge has a dispensing nozzle on one end that dispenses caulk during a caulking operation. The cartridge has a dispensing nozzle on one end that dispenses caulk during a caulking operation. The caulk is forced from the cartridge by a movable wall within the cartridge that moves toward the dispensing end and forces the caulk from the cartridge through the dispensing nozzle. The movable wall and related shaft are driven by application of pressure by the user's hand grip upon a related activating piston lever. The hand driven piston lever of a hard driven caulking gun can result in fatigue of the user's hand and an arm. Also, the caulking operation efficiency is influenced by the ambient temperature and the lack of easy flow of the caulk material when the ambient temperature is not suitable for the easy flow of caulk material.

Power driven mechanical caulking guns are available. An example is taught and claimed in U.S. Pat. No. 7,063,240. The powered caulking gun in one embodiment includes an electric motor coupled to a plurality of cams having uneven surface in slidably contact with at least one driving lever slidably positioned on a piston shaft. The piston shaft includes a piston end that is configured to engage with a cartridge to dispense fluids such as caulks.

Other aspects of mechanical caulking guns are taught in the prior art. U.S. Pat. No. 7,032,786 teaches and claims a caulking gun that includes a gun body, a push rod, a push plate, an adjusting seat, a driving member and an elastic member. The adjusting seat is movable in the gun body by rotation of the driving member to adjust the incline angle of the push plate by guidance of the tapered face of the adjusting seat to increase the incline angle of the locking hole of the push plate to lock and move the push rod without having to replace the push plate. Additionally, U.S. Pat. No. 7,032,784 teaches and claims a caulking gun comprising a gun body, a connector secured on one end of the gun body, and a hanging hook adjustably positioned on the connector wherein the connector has a first end formed with a threaded rod secured on the gun body. Thus the angle and position of the suspension of the hanging hook can be adjusted to fit the user's requirement.

Thus as noted above, various modifications and adjustments of caulking guns have been taught and claimed. U.S. Pat. No. 7,163,130 B teaches and claims a hand held dispensing device comprising a portable gas powered fluid dispenser for caulking tubes and sausage-type containers, grease tubes, tubes containing sealants, adhesives, and mastics, prepared food in containers and the like. The device comprises a sealable container, for a disposable viscous fluid wherein a compressed gas powers the movement of the viscous contained fluid.

### SUMMARY OF THE INVENTION

The instant invention comprises a caulking gun with an insulation wrap to heat caulking materials when the ambient temperature of the work area is of a temperature below the temperature which would allow the caulk material to flow easily in an application. The insulation wrap which encloses the caulking gun and a cartridge containing the caulk material has a heating element of Ni-chrome wires contained within a mesh structure of the insulation wrap contoured to provide an enclosure over the caulk cartridge. A rechargeable battery positioned within this insulation wrap provides power to the heating wires. Elongated metal hinge face plates provide a close fit of the contained heating element to the caulk cartridge by means of the adjustable moveable face plates of the hinge.

### BRIEF DESCRIPTION OF THE DRAWINGS

FIG. 1 is a pictorial representation of the heated caulking gun with the insulation wrap around the caulking gun with the piston lever and piston rod visible.

FIG. 2 is a pictorial representation of the unwrapped insulation wrap around the push rod of the caulking gun.

FIG. 3 is a representation of the insulation wrap showing the enclosed heating element in the insulation wrap wherein the heating element comprises enclosed loops of heating Ni-chrome wires in the contour shape of the heating element.

FIG. 4 is a prospective end view of the insulation wrap wherein the contour shape of the heating element is supported upon a mesh structure.

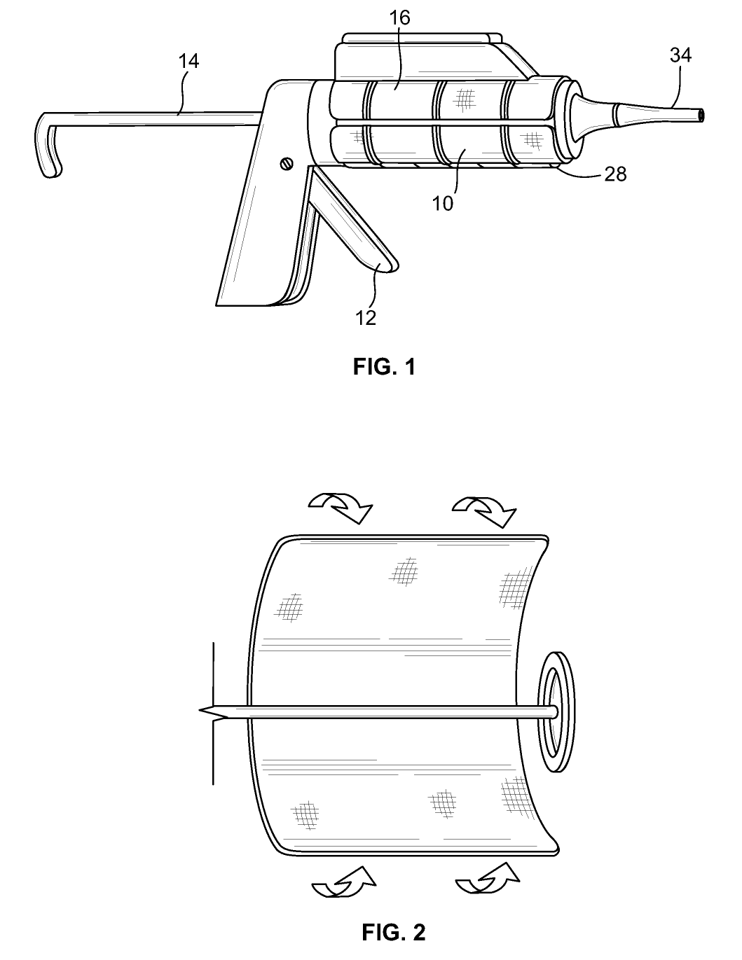

### DETAILS OF THE INVENTION

The insulation wrap which contains the heating element is attached to the heating element by two elongated hinges. The heating element extends a predetermined length and is positioned on the contained caulking cartridge. The length of the hinges stabilizes the application of the heating element to the cartridge surface and permits close application of the heating element to the cartridge to improve the efficiency of the heat transfer to the cartridge surface. The designated hinges are typical metal hinges, conventionally termed “piano hinges” because of the close fitting together of the hinge face plates. The close fit of the hinge face plate as applied to the application of heat to the caulk cartridge surface is an essential element of efficient application of heat to the caulk cartridge in application of the present invention.

The wrap material of the insulated wrap is in accordance with UL ratings and is non-flammable material. The reusable wrap material is preferably an easily cleaned material, whether by manual washing using a suitable detergent or by other cleansing methods, reusable through many application cycles. The material is preferably of a suitable composition and structure that retains heat to maintain a constant temperature of the heated caulk material. Natural fibers such as cotton and wool can be fibers of choice for the wrap material after treated to be non-flammable.

The insulation wrap therefore comprises insulation material enclosed within the outer wrap therefore material. The thickness of the insulation material as contained within the outer wrap material provides a suitable heat containing layer of necessary insulation. The insulation wrap comprises an insulation material of a composition that retains heat to maintain a constant temperature of the heated caulk material. The insulation material accordingly comprises a layer of insulation material selected from the group consisting of glass fiber, fiber of a mineral or clay or wood fiber, alumina or silica or silicon fibers or of other comparable compositions and materials non-flammable in nature. The heating element comprises Ni-chrome heating wise of a nickel-iron alloy containing chromium having high electrical resistance and stability at high temperatures wherein the Ni-chrome wire is positioned on a flexible mesh support material of heat resistant composition a series of multiple u-shaped members wherein the Ni-chrome wires are enclosed within two aluminum metal foil sheets that provide improved heat transfer efficiency of the Ni-chrome wires to the surface of the enclosed caulk material within the caulk cartridge in proximate contact with the wires of the heating element.

An aspect of the insulation wrap is the fabric is thin enough that the fabric does not change the caulk gun configuration and is resistant to tearing.

In a preferred embodiment rechargeable batteries are housed and used to supply power to the heating element to provide freedom of movement to the caulking gun apparatus without necessity for electrical power cords to be attached to the heating element. The rechargeable batteries can be housed in the handle assembly of the caulking gun with power leads contained within the handle. The handle assembly of the preferred embodiment provides an easy screw-on lid at the bottom of the handle to hold the batteries in place. An off-on switch is connected to the batteries in the handle assembly.

Additionally, the caulking gun apparatus can house a means of providing power to the heating element comprising a rechargeable batteries housed in the top portion of the chamber of the caulking gun apparatus with power leads contained within the top chamber, where the inner surface of the top portion of the chamber lid of the caulking gun holds the power source in place.

The off-on switch can include different temperature control settings to control the heat delivered to the caulk cartridge material.

The objective of the instant invention is to provide a caulking gun apparatus that will provide a constant flow of heated caulking material at a temperature not affected by outside ambient temperatures.

The objective of the instant invention is to provide an efficient caulking gun apparatus that will provide a suitable means of heating a caulk cartridge containing caulk material in an efficient heating method wherein heat is applied to commercially available cartridge of caulking material.

A further object of the instant invention is to provide a method of applying heat to cartridges of caulk material wherein the cartridges are not consistently of uniform size but typically are of circular tube shape that fits within a caulk gun enclosure.

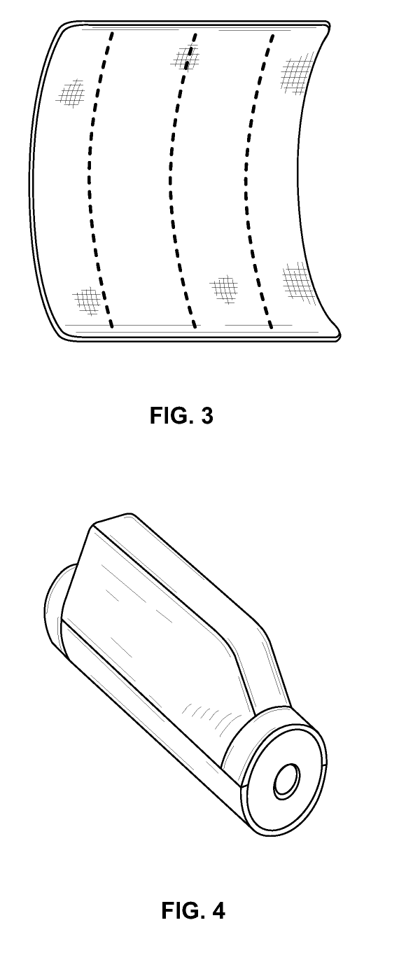

With reference to FIG. 3, the insulation wrap 10 is illustrated with sub-section 11 and 12 of wrap 10 attached to heating element 15 with elongated metal hinges 40 and 41. Hinges 40 and 41, sometimes termed “piano hinges” are typically of elongated structure with close fitting hinge face plates which closely fit the proximate enclosed surface of the enclosed caulking material cartridge (not shown) enclosed within the enclosure of the caulking gun. The close fit of the heating element encapsulated in a mesh structure surrounding the cartridge containing the caulking material is an essential element of the instant invention. The efficient application of heat to the caulking material cartridge within the enclosure of the insulation wrap is required for efficient application of the heated caulking gun using commercially available caulking material in commercially available cartridges.

Two snap catches 21 and 22 in FIG. 3 are attached to the exterior surface end 18 of insulation wrap section 11 to mesh with snap catches 23 and 24 attaches to exterior end surface 19 of insulation wrap section 12 to provide a wrap enclosure of the enclosed cartridge (not shown).

Heating element 15 structure comprises Ni-chrome heating wire of a nickel base allow containing chromium and iron having high electrical resistance and stability at high temperatures. The Ni-chrome wire is positioned upon a flexible mesh material of heat resistant composition as a series of multiple U-shaped members upon the mesh structure to form a heating structure of Ni-chrome wire of side-by-side heating members. The Ni-chrome wire structure of side-by-side U-shaped members is encapsulated within two aluminum metal foil sheets to improve heat transfer of the heating element 15 structure.

Heating element structure 15 is attached to metal hinges 40 and 41 to provide a contour fit of heating element structure 15 to the contour surface of the rounded surface of the caulking material cartridge contained in the caulking gun cartridge enclosure.

Referring to FIG. 3, exterior surface 32 of insular wrap 10 comprises wash-able fabrics which are treated to the non-flammable. It is of flexible body material that does not change the caulk gun configuration and is resistant to being torn. The flexible material 32 is an insulating fibrous material such as glass fiber, and mineral or clay or wood fibers, aluminum, silicate or silicon fibers, and the like to provide thermal resistance to heat.

The exterior surface 32 and interior surface 31 of insulation wrap 10 comprise a washable fabric selected from the group of fabrics consisting of polyesters, olefin and cellulose acetate materials.

With reference to FIG. 3, a pictorial representation of the caulking gun enclosed in the insulation wrap 10 is presented. A recharge-able battery is enclosed in a section of the insulation wrap 10:

The off-on switch for the batteries is located at the exterior end of the heated caulking gun apparatus.

The handle assembly may include an electric power cord to supply electric power to the heating element 15 to eliminate dependency upon batteries as a source of electric current for power to the heated caulking gun apparatus. The electric current power supply assembly may contain a temperature control mechanism to provide for selection of the amount of heat needed by the user to the insulation wrap with an adequate range to keep the caulk material flowing evenly. The heated caulking gun apparatus may be provided with an electric motor to provide for dispensing of caulk form the cartridge wherein the heating element of the caulking gun is operated in conjunction on an electric motor. The rechargeable batteries may constitute a source of power for both the electric motor and for the heating element; means may be utilized for prevention of movement and shifting of the caulk cartridge within the caulk gun cartridge enclosure such as hooks, Velcro aids or other means of attachment to control movement of the cartridge within the caulking gun apparatus. The means of attachment of the caulking material can aid an even disbursement of the caulk material.

While the application is directed to one embodiment of the present invention, other and further embodiments of the invention may be devised without departing from the basic scope of the invention wherein the scope thereof is determined by the following descriptions of alternative embodiments and claims which follow.

What is claimed is:

1. A caulking gun apparatus for applying a even flow of heated caulking material to objects during periods for cold ambient temperature not conducive to ready flow of fluid caulking material, the caulking gun apparatus comprising:
a. an insulation wrap containing a heating element, an off-on switch for the heating element, a means of providing electric power to the heating element and a means of controlling an amount of electric power to the heating element and a close proximate contact is provided between the heating element in the insulation wrap of caulk material.
b. a caulking gun having a receiving chamber to receive a cartridge of caulking material;
c. a cartridge container of caulking material of a shape suitable to be enclosed within a receiving chamber of a caulking gun for dispensing of the caulking material.

2. The caulking gun apparatus of claims 1 wherein the insulated wrap comprising:
a. a heating element axially coupled to an extending receiving chamber of the caulking gun;
b. a layer of insulation material contained within the outer wrap material surface of the insulation wrap;
c. an outer wrap material of a composition of natural or artificial fibers easily cleaned and reusable through many application cycles wherein the structure of the insulated wrap does not change the caulk gun configuration
d. wherein the heating element is coupled to sections of the insulated wrap by two elongated metal hinges extending the length of the attached heating element and up to a majority of the length of the cartridge container of caulk material, the heating element contained to fit the outer surface of the caulk cartridge.

3. The heating element of claim 2 wherein the heating element comprises a Ni-chrome heating wire of a nickel-iron alloy containing chromium and having high electrical resistance and stability at high temperature where the Nic-chrome wire is positioned on a flexible mesh support material of heat resistant composition as a series of multiple U-shaped members to form a heating structure of N-chrome wire of side-by-side heating U-Shaped members and wherein the Ni-chrome wire structure is encapsulated within a plurality of aluminum foil sheets that provide improved heat transfer of the heating Ni-chrome wires to cartridge surface of the caulk material cartridge.

4. The caulking gun apparatus of claim 1 wherein the means of providing power to the heating element comprises batteries.

5. The caulking gun apparatus of claim 1 wherein the means of providing power to the heating element comprises an electric power cord coupled to an outside power source.

6. The caulking gun apparatus of claim 1 wherein the cartridge of caulking material comprises tubular containers of commercially available cartridges of caulk material.

7. The caulking gun apparatus of claim 1 wherein the heating element comprises two elongated metal hinges extending the leaves of the attached heating element wherein the leaves of the plurality of hinges open and closed to closely fit the outside surface of the enclosed caulking material cartridge without any loss of contact between the heating element and the surface of the caulk material cartridge.

8. The caulking gun apparatus of claim 1 wherein the heating element comprises temperature controls of the heating element output;

9. The caulking gun apparatus of claim 1 wherein the insulated wrap comprises material of a composition that retains heat to maintain a constant temperature of the heated caulk material.

10. The caulking gun apparatus of claim 1 wherein the insulated wrap comprises a layer of insulation material selected from the group consisting of glass fiber, fibers of mineral or clay or wood fibers, aluminum silicate or silicon fibers and other compositions and materials that are light weight and non-flammable.

11. The caulking gun apparatus of claim 1 wherein the means of providing power to the heating element comprises rechargeable batteries housed in a handle assembly of the caulking gun apparatus with power leads contained within the handle with a screw-on lid which holds the batteries in place within the handle.

12. The caulking gun apparatus of claim 1 wherein the means of providing power to the heating element comprises rechargeable batteries housed in the top portion of the chamber of the caulking gun apparatus with power leads contained within the top chamber, where the inner surface of the top portion of the chamber of the caulking gun holds the power source in place.

13. The caulking gun apparatus of claim 1 wherein a close proximate contact between the heating element and cartridge of caulk material is provided y the elongated metal hinges extending along the length of the heating element and up to a majority of the longitudinal length of the caulk material cartridge wherein the leaves of the metal hinges open and closed to provide close proximate contact with the surface of the enclosed caulk cartridge without any loss of contact between the heating element and surface of the caulk cartridge.
